(19) United States
(12) Patent Application Publication
(10) Pub. No.: US 2005/0116481 A1
(43) Pub. Date: Jun. 2, 2005

(54) Race car safety system

(76) Inventor: Gerard A. Blahut, Bensalem, PA (US)

Correspondence Address: Frank A. Mazzeo;Frank A. Mazzeo, P.C., Suite 200, 808 Bethlehem Pike, Colmar, PA, 18915, US

(21) Appl. No.: 10/956,881

(22) Filed: Oct. 1, 2004

Related U.S. Application Data
(60) Provisional application No. 60/507,866, filed on Oct. 1, 2003.

(51) Int. Cl. B60R 19/00

(52) U.S. Cl. 293/17

(57) ABSTRACT

A race car safety system comprising a car with at least one roller or shoe positioned on the exterior of the car so that the roller or shoe will come into contact with a racetrack outer wall if the car contacts the outer wall. In another embodiment, in addition to the roller or shoe on the race car, the racetrack outer wall will have a hard strip at the position where contact with the roller or shoe is likely to occur.

### CROSS REFERENCE TO RELATED APPLICATION(S)

This application claims the benefit of U.S. Provisional Application No. 60/507,866 filed on Oct. 1, 2003, which is incorporated by reference as if fully set forth.

### FIELD OF INVENTION

The field of the invention is safety systems for car racing.

### BACKGROUND

The high rate of speed of race cars has been a factor in making car racing a popular and growing sport in the United States and around the world. Unfortunately, the high speed also makes the sport a very dangerous one. Accidents, sometimes fatal, do occur.

Stock car racing, in particular, has become very popular in the U.S. The most well-known organization for this type of racing is the National Association of Stock Car Auto Racing (NASCAR). In NASCAR racing, sedan cars race around an oval track. Along the outer perimeter of the track is an outer wall to protect the spectators. Many accidents in NASCAR racing occur as a result of the cars drifting into or colliding with the outer walls at a high rate of speed.

In an effort to reduce this danger, NASCAR has begun utilizing the Steel and Foam Energy Reduction (SAFER) system, also referred to as “soft walls.” These soft walls are placed all around outer walls of certain NASCAR tracks. The soft walls are designed to cushion a car that hits the outer wall with the intention of reducing the likelihood of a serious accident. However, as will be more fully described below, the soft walls may have a serious and dangerous shortcoming. The soft walls may cause cars drifting into the walls to stick to the walls instead of safely sliding along the walls. As a result, the soft walls may actually increase the likelihood of a dangerous accident.

An object of this invention is to provide an alternative system to the soft wall system currently employed by NASCAR that better reduces the likelihood of race car accidents involving the outer walls. In this regard, it is a further object of this invention to provide a race car safety system in which race cars safely slide along a race track outer wall upon impact, rather than stick to the outer wall.

### SUMMARY

The present invention overcomes the shortcomings of the prior known race safety systems. Briefly stated, the invention provides a race car safety system comprising a car with at least one roller or shoe positioned on the exterior of the car so that the roller or shoe will come into contact with a racetrack outer wall if the car contacts the outer wall. In another embodiment, in addition to the roller or shoe on the race car, the racetrack outer wall will have a hard strip at the position where contact with the roller or shoe is likely to occur.

### BRIEF DESCRIPTION OF THE DRAWING(S)

The features and advantages of the various embodiments will become apparent from the following detailed description in which:

FIG. 1 illustrates a top view of an exemplary race car, according to one embodiment.

FIG. 2 illustrates a right side view of the exemplary race car of FIG. 1.

FIG. 3 illustrates a top view of an exemplary race car on an exemplary race track colliding with an outer wall.

FIG. 4 illustrates an exemplary race car, according to one embodiment, that includes a shoe integrated into the body of the race car.

FIG. 5 illustrates an exemplary race car, according to one embodiment, that includes a shoe placed on top of a telescoping crush post.

FIG. 6 illustrates a top view of an exemplary race car colliding with an exemplary outer wall that includes a strip, according to one embodiment.

FIG. 7 illustrates a side view of the exemplary race car and outer wall of FIG. 6.

FIG. 8 illustrates a top view of an exemplary roller-shoe apparatus on a race car, according to one embodiment.

FIG. 9a illustrates an exemplary path of a race car that experiences sticking to an outer wall after a collision.

FIG. 9b illustrates an exemplary path of a race car that experiences sliding along and off of an outer wall after a collision.

FIG. 10 illustrates two exemplary velocity vectors of a race car driving near an outer wall.

### DETAILED DESCRIPTION OF THE PREFERRED EMBODIMENT(S)

In the Figures, the same numerals are used to indicate the same or similar parts.

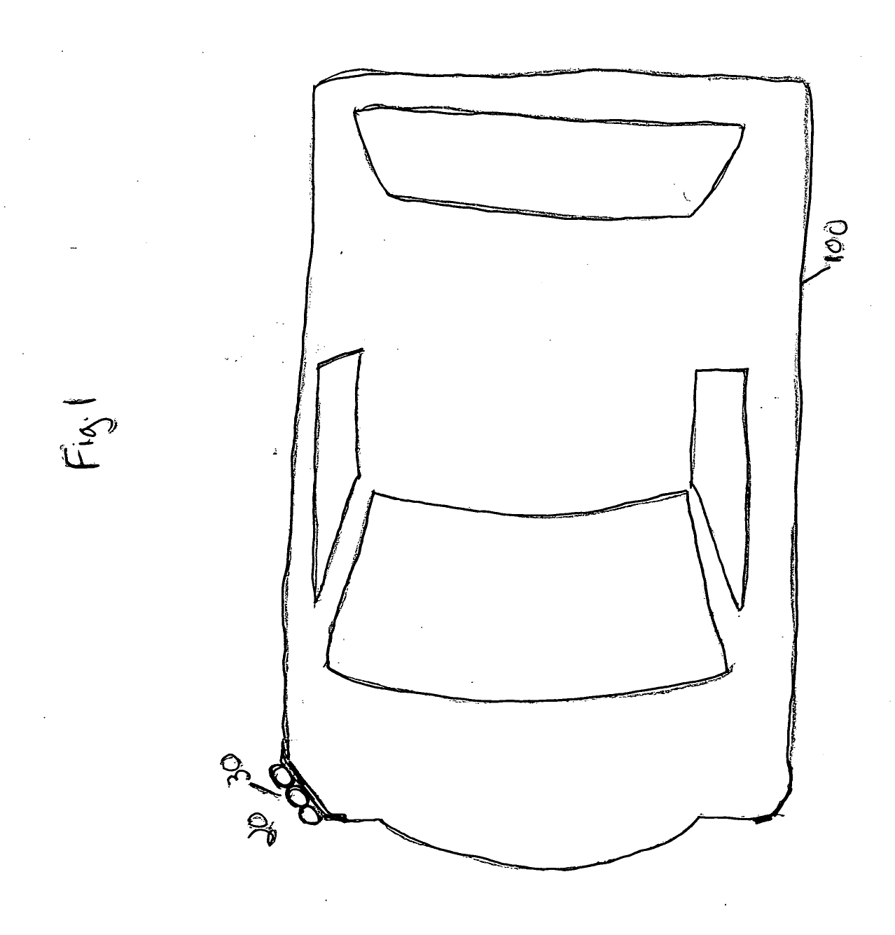

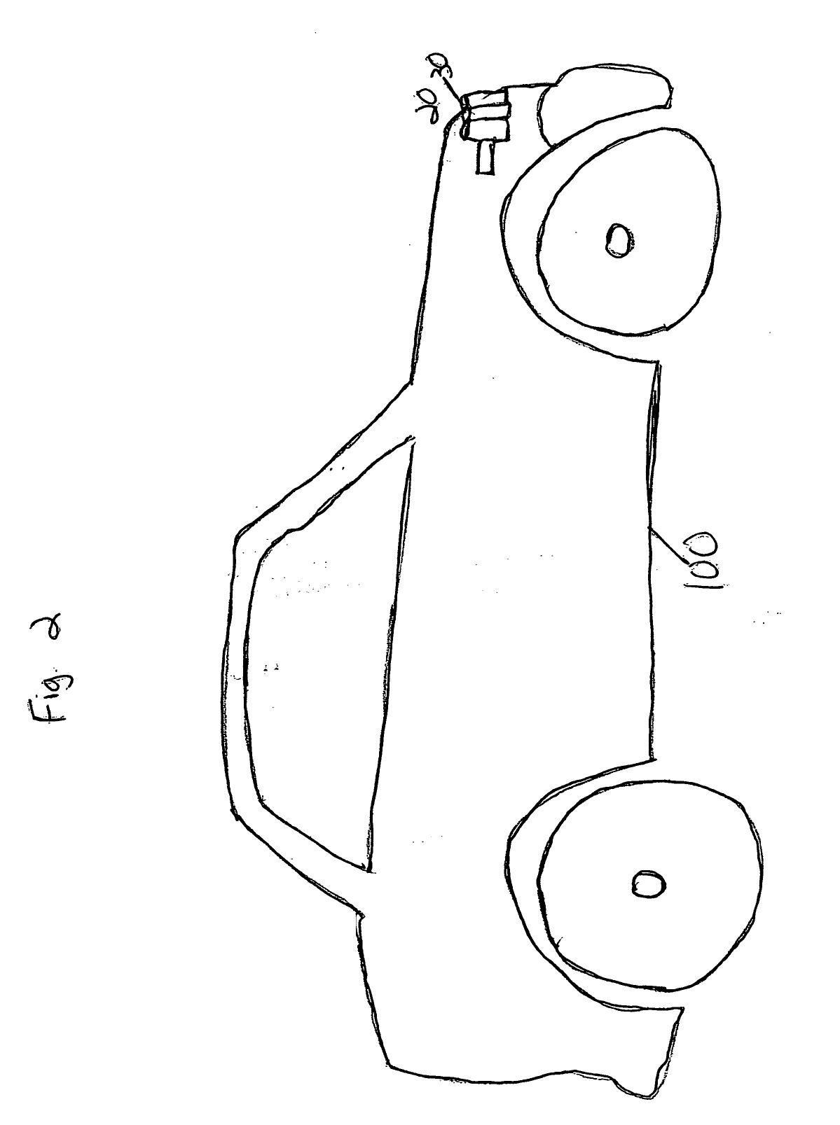

FIG. 1 illustrates a top view and FIG. 2 illustrates a right side view of an exemplary race car 100. A right front corner 20 of the car 100 includes rollers 30. As illustrated, there are three rollers 30. However, the invention is in no way limited thereto. Rather as one of ordinary skill in the art would recognize any number of rollers 30 could be used without departing from the scope of the current invention. The rollers 30 are attached to an exterior of the car 100. The rollers 30 may be attached to the car 100 in a variety of ways that would be obvious to one of ordinary skill in the art.

The rollers 30 are preferably made of a hard material. The hard material should at least be hard enough to withstand an impact of the car 100 and a race track outer wall. However, the hard material needs to still permit metal forming processes. One example of a hard material that can withstand the impact but is still formable is manganese steel.

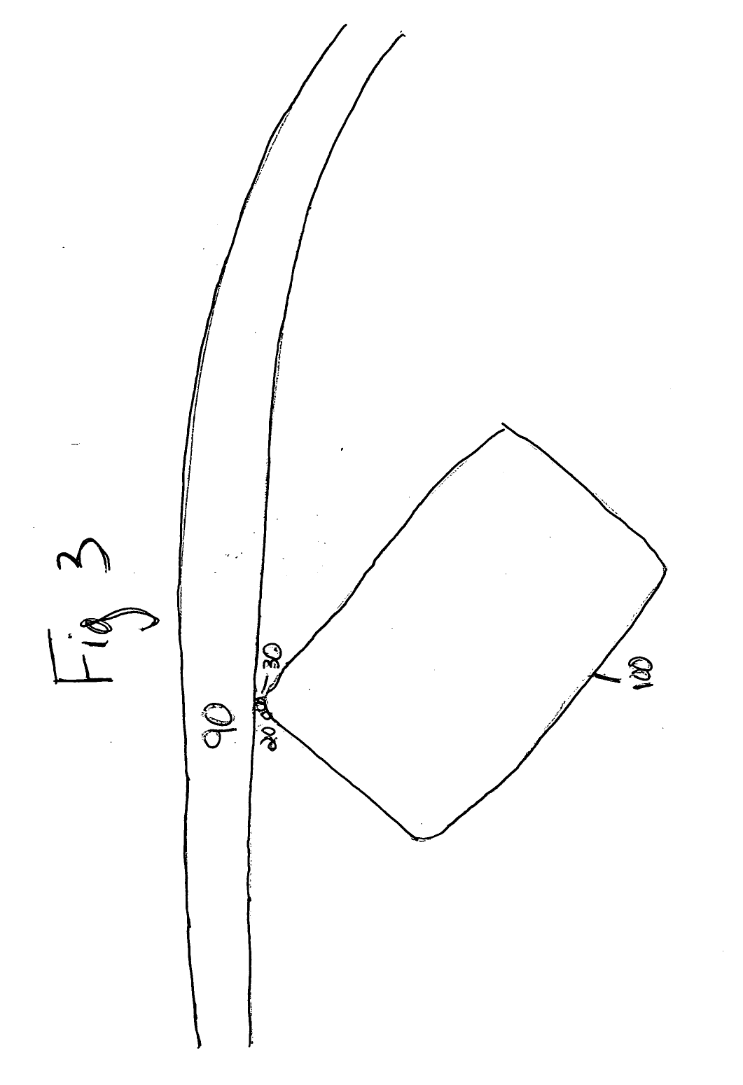

FIG. 3 illustrates a top view of the race car 100 on an exemplary race track. The rollers 30 are positioned such that the rollers 30 will impact an outer wall 90 of the race track in a situation where the car 100 collides with the outer wall 90. Since the most likely point of contact on the car 100 is at the right front corner 20, the rollers 30 should at least be located at that corner. The second most likely point of contact is the left rear corner, since that is where the impact would occur if the car 100 made a 180 degree spin. According to one embodiment, the rollers 30 are also placed at the left rear corner as well. In additional embodiments, the rollers 30 can be on additional corners or on all four corners of the car 100. There also could be rollers 30 all around the car such that the rollers 30 will come in contact with the outer wall 90 regardless of the position the car 100 when it impacts the outer wall 90.

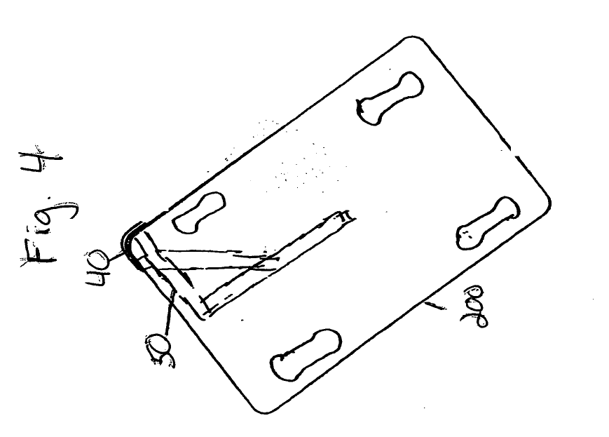

FIG. 4 illustrates an exemplary car 200 that includes hard matter on the right front corner of the car 200. This hard matter will hereinafter be referred to as a shoe 40. The shoe 40 should be positioned at the right front corner since this is the location on the car 200 most likely to come in contact with the outer wall 90. The shoe 40 should also be made of a hard matter that is formable. Additionally, shoe 40 may also be located at the left rear corner, a plurality of corners, or all around the car 200, as discussed above with respect to the rollers 30. As illustrated in FIG. 4, the shoe 40 is integrated into a body 50 of the car 200. However, the invention is in no way limited thereto. Rather, as one of ordinary skill in the art would recognize, the shoe 40 can be attached to the car 200 in a variety of ways without departing from the scope of the current invention.

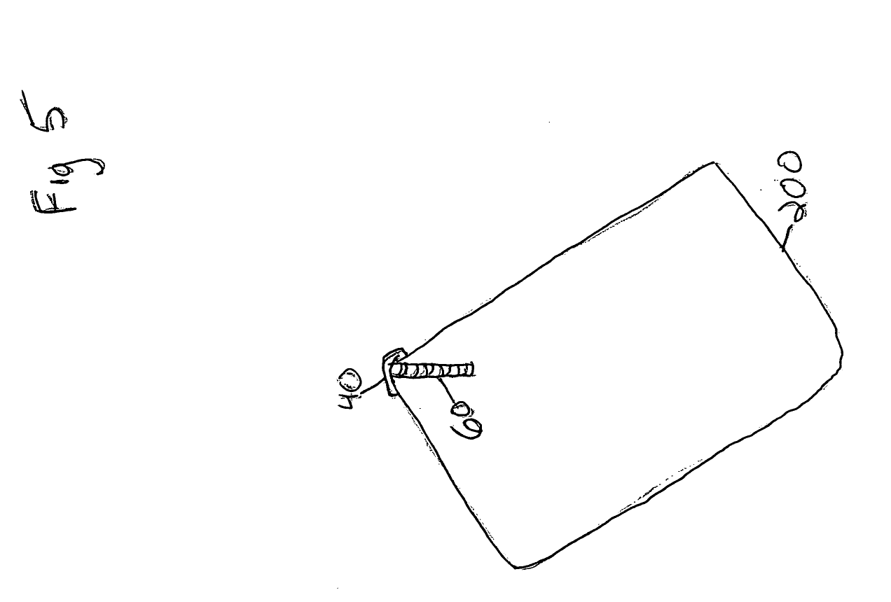

FIG. 5 illustrates an embodiment in which the shoe 40 is at the top of a telescoping crush post 60. The crush post 60 is designed to give on impact at a certain amount of force. Preferably, the crush post 60 absorbs the perpendicular motion, toward the wall, of the car 200 as it collides into the outer wall 90. In one preferred embodiment, the crush post 60 will be in line with the center of gravity of the car 200. While the crush post 60 will absorb some of the force, the crushing of the sheet metal of the car 200 will absorb the remainder. In some collisions between car 200 and outer wall 90, the amount of crushing could be as much as one foot in distance.

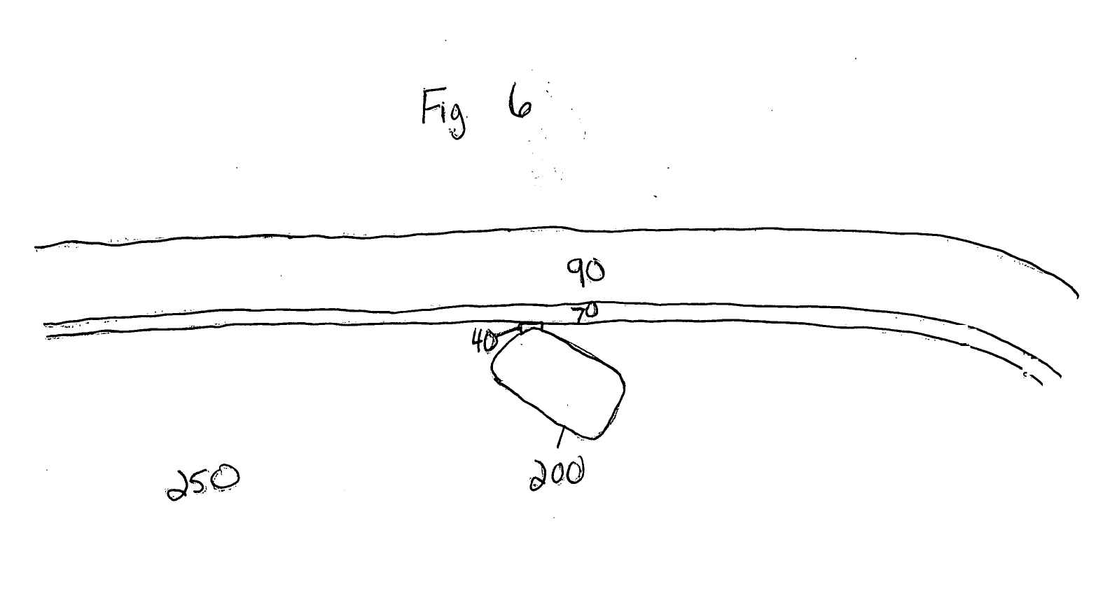

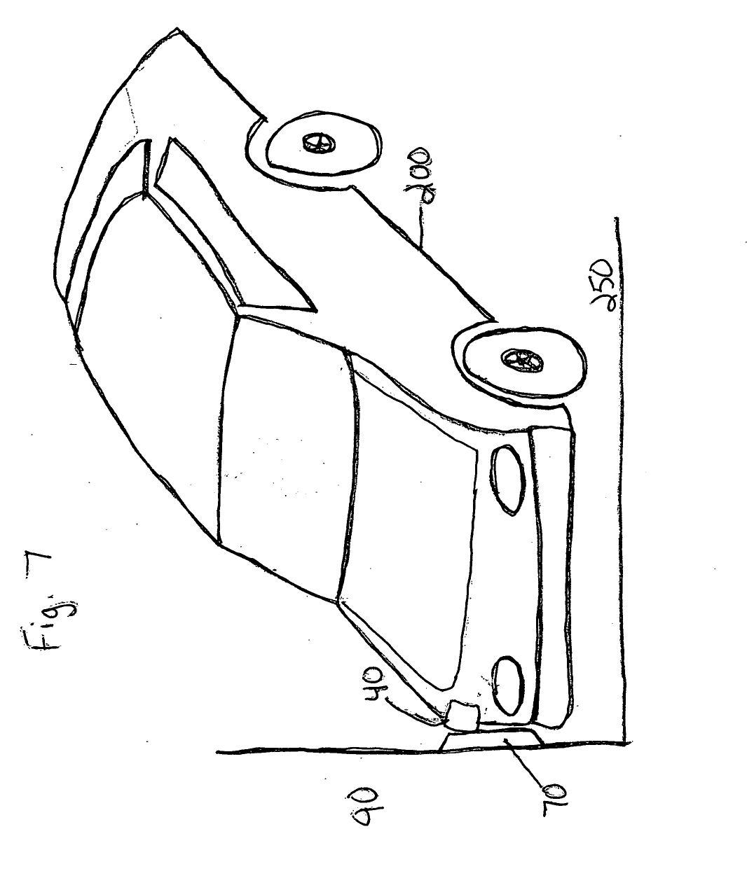

FIG. 6 illustrates a top view and FIG. 7 illustrates a side view of an exemplary track 250. An outer wall 90 of the track 250 includes a strip 70. The strip 70 is located on the side of the outer wall 90 facing the race track. The strip 70 is preferably at a height off the ground and sufficiently wide so that the shoe 40 or rollers 30 will come in contact with the strip 70 when the car 200 or 100 impacts the outer wall 90. In a preferred embodiment, the strip 70 covers the entire side of the outer wall 90 that faces the race track.

The strip 70 is preferably made of a hard matter. Examples of hard matters that could be used include high carbon cast iron or steel. The strip 70 is preferably attached firmly to the outer wall 90, which is likely made of concrete, such that the strip 70 will not be damaged by the most violent contact by the car 200.

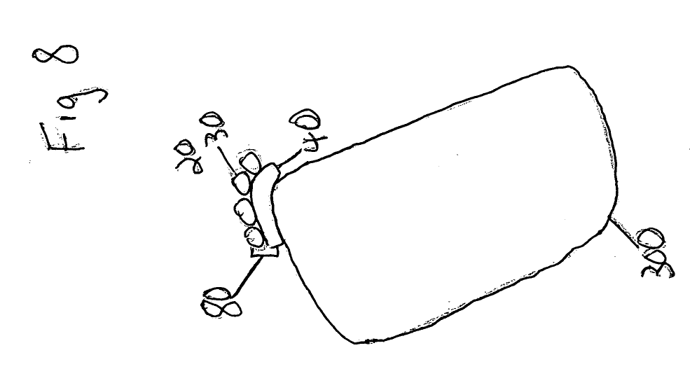

FIG. 8 illustrates an exemplary roller-shoe apparatus 80. The roller-shoe apparatus 80 includes rollers 30 that are part of or attached to the shoe 40. With the roller-shoe apparatus 80, the rollers 30 are on the outside and impact the outer wall 90 upon collision.

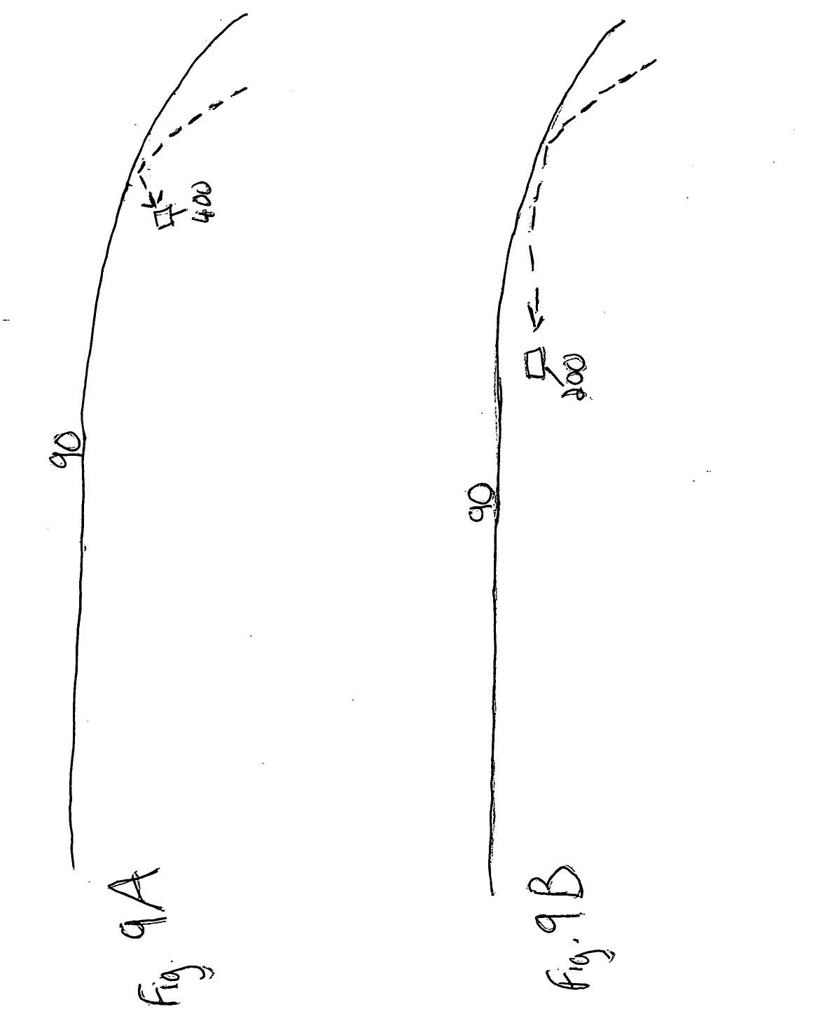

FIGS. 9a and 9b illustrate how the invention makes race car driving safer. FIG. 9a illustrates the path of a race car into an outer wall in which the car 400 has no roller 30 or shoe 40. As illustrated, the car 400 contacts the outer wall and no sliding along the wall occurs, or minimally occurs. The path shown depicts a car 400 sticking to the outer wall upon impact and being damaged thereby.

Alternatively, FIG. 9b illustrates what happens to a car 200 with a roller 30 or shoe 40 that takes the same path towards impact with the outer wall 90 as the car 400 in FIG. 9a. As illustrated, the car 1 slides or skids along the outer wall 90 after impact. This occurs because there is less friction between two hard objects than there is between two softer objects. Therefore, the car 200 is more likely to safely slide down and off the outer wall 90 if the point of contact is between the rollers 30 or shoe 40 and the outer wall 90, than if the contact is between the car bumper and the “soft wall” outer wall (SAFER system). Contact between a roller 30 or shoe 40 and a strip 70 would generate even less friction and, therefore, further increase the likelihood of the car 200 safely sliding after an impact. The purpose of the shoe is to increase the car's ability to slide along the racetrack wall after impact, rather than to “stick” to the wall upon impact.

As mentioned above, the rollers 30 or shoe 40 and strip 70 should be made of hard material. In addition to reduced friction between two parts made of hard material, there also is a reduced likelihood of spalling.

A major factor in the danger of an accident in a car race is the sudden deceleration of the car 200 after a collision into the outer wall 90. The sudden deceleration of the car can seriously injure a driver even if the driver is secured by a safety belt/harness system. The race car safety system described in the invention reduces deceleration forces on NASCAR-type sedans when a contact is made between car and outer wall. This type of contact often occurs after the car 200 has just made a turn and approaches the straight section of the outer wall 90, especially on large racetracks, or “super speedways.” It is at this point that cars 200 are inadvertently contacted by following cars due to differences in speed and “line” used when coming off a long sweeping turn.

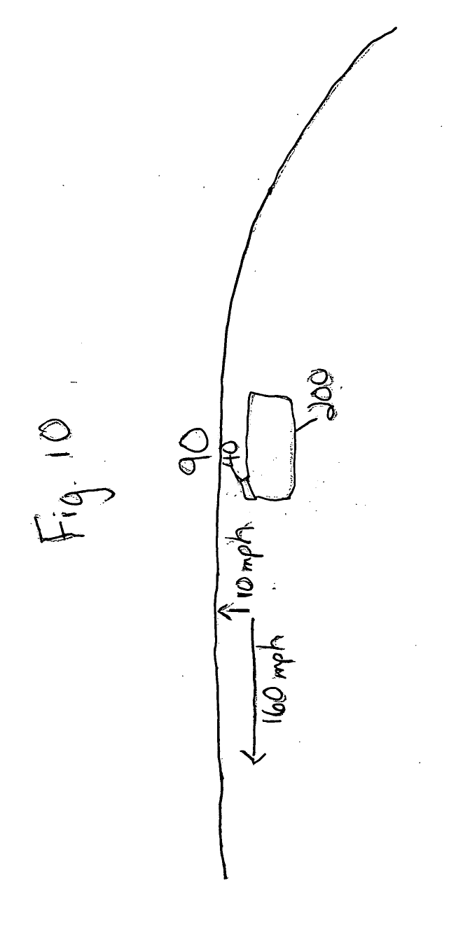

FIG. 10 illustrates an example of the possible speeds at which the car 200 can be traveling in two vectors: 1) parallel with the outer wall (“parallel vector”), and 2) towards the outer wall (“perpendicular vector”). Typically, the perpendicular vector (velocity towards the wall) is only 5 or ten miles per hour, while the parallel vector (velocity parallel to the wall) can be as great as 165 mph. The parallel vector is the vector that poses the greatest danger of injury to the driver. As described above, the invention reduces the likelihood injury from traveling at the high rate of speed of the parallel vector by reducing the likelihood of a sudden deceleration of the car after an impact with the outer wall 90.

Whether the car colliding with the outer wall sticks to the outer wall, and, therefore, sudden deceleration occurs, or the car slides along the wall may depend on the angle at which the car hits the outer wall. There is a smaller “safe” angle range with soft walls (walls utilizing the SAFER system, for example) than there is with hard walls (walls utilizing the strip 70, for example). This is because softer outer walls are stickier than hard harder walls. Accordingly, hard walls provide a larger range of angles at which the car can collide with the outer wall and harmlessly slide down and off the outer wall.

In other words, hard material of the car colliding with hard substance of the strip causes reduced coefficient of friction as compared to when a car without hard material collides with a soft wall. This reduced coefficient of friction reduces the calculated width of the critical range of angle within which the car will stick instead of slide.

The following experiment explains the concept of softer walls being stickier: Place a new, unsharpened pencil, eraser down, on a formica table or shelf, with the other end leaning against a smooth vertical surface. If there is no dust to prevent contact, the eraser sticks to the table surface. The angle the pencil makes with the wall can be almost 45 degrees before the pencil slides down. If you tap on the top of the pencil with the handle of a butter knife, the eraser just sticks tighter to the table.

Now put a piece of waxed paper under the eraser end. Obviously, the pencil starts sliding down at a much higher angle. Tapping with the knife on the top end causes the bottom to slip more easily.

This illustrates there is a critical range of angle where the corner of the car tries to stick to the outer wall rather than sliding off. Put another way, there is a critical range of angle within which the resolution of the reactive force of the wall against the car will show a high ratio of perpendicular to parallel force, causing sticking. Also, observation of the film or tape record of various NASCAR crashes shows that the car does not acquire much spin momentum during contact with the wall (only 0.08 seconds in the one case). Therefore, the resolution of the forces can be done without consideration of the spin.

In most cases, when cars collide with outer walls, the cars do not hit a wall straight on. Cars usually negotiate most of the turn, and run into the wall at a low angle, while heading for the straight portion of the track. This was the case in the well-known fatal accident involving Dale Earnhardt.

The invention accomplishes two conditions in complete opposition to the theory of the soft walls. First, the energy absorbing property of the soft wall is switched to the vehicle, whereas the wall is hardened. Second, the soft walls have exhibited a stickiness even worse than the concrete wall. The friction between the two hard metals will be one eighth of this amount, or less.

1. A race car safety system comprising a car with at least one roller positioned on an exterior of the car so that the roller will come into contact with a racetrack outer wall if the car contacts the outer wall.

2. The system of claim 1, wherein the at least one roller is on at least one corner of the car.

3. The system of claim 1, wherein the at least one roller is on the right front corner of the car.

4. The system of claim 1, wherein the at least one roller is made of a hard material.

5. The system of claim 1, wherein the hard material of the at least one roller is manganese steel.

6. The system of claim 1, wherein the car includes a frame and the at least one roller is integrated into the frame.

7. The system of claim 1, wherein the car includes a crush post and the at least one roller is attached to the crush post.

8. The system of claim 1, further comprising a strip made of a hard substance attached to the race track outer wall, at a height that the strip will contact the at least one roller if the car contacts the outer wall.

9. The system of claim 1, wherein the hard substance of the strip is high carbon cast iron or steel.

10. A race car safety system comprising a car with a least one shoe on the car's exterior at such a location on the car so that the shoe will come into contact with a racetrack outer wall if the car contacts the outer wall.

11. The system of claim 10, wherein the at least one shoe is on at least one corner of the car.

12. The system of claim 10, wherein the at least one shoe is on the right front corner of the car.

13. The system of claim 10, wherein the at least one shoe is made of a hard matter.

14. The system of claim 10, wherein the hard matter of the at least one shoe is manganese steel.

15. The system of claim 10, wherein the car includes a frame and the at least one shoe is integrated into the frame.

16. The system of claim 10, wherein the car includes a crush post and the at least one shoe is attached to the crush post.

17. The system of claim 10, further comprising at least one roller attached to the top of the shoe such that the roller contacts the racetrack outerwall.

18. A race car safety system comprising a hard material on an exterior of a car, a hard substance on a racetrack outer wall so that the hard material and the hard substance will come into contact if the car collides into the outer wall.

19. The system of claim 18, wherein the hard material is a shoe.

20. The system of claim 18, wherein the hard material is a roller.
